(19) United States
(12) Patent Application Publication
(10) Pub. No.: US 2005/0143094 A1
(43) Pub. Date: Jun. 30, 2005

(54) Methods, systems and computer program products for providing a wireless fidelity hotspot locator

(76) Inventors: James Reed, Marietta, GA (US); David Lassing, Atlanta, GA (US); John Pumpelly, Atlanta, GA (US)

Correspondence Address: Philmore H. Colburn II;Cantor Colburn LLP, 55 Griffin Road South, Bloomfield, CT, 06002, US

(21) Appl. No.: 10/746,187

(22) Filed: Dec. 24, 2003

(51) Int. Cl. H04Q 7/20

(52) U.S. Cl. 455/456.2

(57) ABSTRACT

A method for providing a wireless fidelity hotspot locator including receiving a communication from a communications device requesting to locate a wireless fidelity hotspot. A location of the communications device is determined. A wireless fidelity hotspot site that corresponds to the location is determined. Address information for the hotspot site is transmitted to the communications device.

### FIELD OF THE INVENTION

The present disclosure relates generally to methods for providing a wireless fidelity hotspot locator and in particular, to methods of providing a wireless fidelity hotspot locator using a cellular network.

### BACKGROUND OF THE INVENTION

Wireless networking refers to technology that supports communication between computers and other electronic devices using standard network protocols, but without physical cabling. Increased use of laptop computers, personal digital assistants (PDAs) and other mobile computing and communications devices, along with an increase in worker mobility has helped fuel the demand for wireless networks. The maturing of industry standards and the deployment of lightweight wireless hardware across a broad market spectrum has also played a role in fueling the demand for wireless networks. The most widely used standard for wireless networking is Institute of Electrical and Electronic Engineers (IEEE) 802.11. Most hardware vendors support IEEE 802.11, which assists in allowing interoperability between hardware manufactured by two or more vendors. IEEE 802.11 networks are often referred to as wireless fidelity, or WIFI, networks. A typical indoor range for a wireless network is one hundred and fifty to three hundred feet, with performance likely to degrade as the distance increases. Typical outdoor ranges for wireless networks are approximately one thousand feet and depend on a number of factors such as atmosphere conditions and physical obstructions.

Wireless LAN service locations, that allow computer users to access the Internet via laptop and/or hand-held computers are increasing in popularity. These wireless fidelity access points are referred to as hotspots and are currently located in many airports, hotels, restaurants, coffee shops and convention centers. Wireless fidelity use is expected to continue to grow and many of the major notebook computer manufacturers currently ship products that include an embedded wireless network interface card (NIC). One problem associated with wireless fidelity hotspot usage is that it is sometimes difficult to locate a wireless fidelity hotspot in a nearby geographic location. A practice termed “warchalking” has been emerging. Warchalking entails drawing a chalk symbol on a wall or pavement to indicate the presence of a wireless networking node. When a computer user who wants to access the Internet comes across one of these symbols, it is a sign that it is a wireless fidelity hotspot location. Warchalking however, is not a complete nor reliable system because it is based on an ad-hoc process of the public discovering wireless fidelity nodes, whether commercial or not, and signaling their presence with chalk symbols. In addition, there has been much discussion about the format of the symbols and what the symbols should signify. Certain retailers and other establishments are installing hotspots in their locations to draw patrons (e.g., Starbucks and McDonald's), but people unfamiliar with the area may not know where these hotspots are located.

A wireless mobility user may have difficulty finding a hotspot location for wireless broadband access. The user may be a traveler and not aware of the closest hotspot location and may not have brought a hard copy listing of the carrier provided wireless fidelity hotspot locations. In addition, the business user may not have the time to search for warchalking symbols to find hotspot locations and may not want to risk the possibility of confidential business data being transferred across networks with unknown security features. Directories of hotspot locations are available on the Internet, but utilizing these directories requires the user to be already logged on to the Internet.

### SUMMARY OF THE INVENTION

Embodiments of the present invention include a method for providing a wireless fidelity hotspot locator. The method includes receiving a communication from a communications device requesting to locate a wireless fidelity hotspot. The location of the communications device is determined. A wireless fidelity hotspot site that corresponds to the location is determined. Address information for the hotspot site is transmitted to the communications device.

Other embodiments of the present invention include a method for providing a wireless fidelity hotspot locator. The method includes determining a location of a communications device that subscribes to a wireless fidelity hotspot locator service. A wireless fidelity hotspot site that corresponds to the location is determined. Address information for the hotspot site is transmitted to the communications device.

Further embodiments of the present invention include a system for providing a wireless fidelity hotspot locator. The system includes an application server and a switch in communication with the application server. The system also includes a wireless fidelity hotspot locator application accessed by the application server for receiving a communication requesting to locate a wireless fidelity hotspot from a communications device via the switch. The location of the communications device is determined and a wireless fidelity hotspot site that corresponds to the location is determined. The address information for the hotspot site is transmitted to the communications device via the switch.

Still further embodiments of the present invention include a computer program product for providing a wireless fidelity hotspot locator. The computer program product includes a computer-readable storage medium that stores instructions for executing the wireless fidelity hotspot locator. The wireless fidelity hotspot locator includes a method that includes receiving a communication from a communications device requesting to locate a wireless fidelity hotspot. The location of the communications device is determined. A wireless fidelity hotspot site that corresponds to the location is determined. Address information for the hotspot site transmitted to the communications device.

Other systems, methods and/or computer program products according to embodiments will be or become apparent to one with skill in the art upon review of the following drawings and detailed description. It is intended that all such additional systems, methods, and/or computer program products be within the scope of the present invention, and be protected by the accompanying claims.

### BRIEF DESCRIPTION OF THE DRAWINGS

Referring to the exemplary drawings wherein like elements are numbered alike in the several FIGURES:

FIG. 1 is a block diagram of an exemplary system for providing a wireless fidelity hotspot locator using a cellular network; and

FIG. 2 is a flow diagram of an exemplary process for providing a wireless fidelity hotspot locator using a cellular network.

### DETAILED DESCRIPTION OF THE INVENTION

Exemplary embodiments of the present invention provide a wireless fidelity hotspot locator for a cellular network user. The wireless fidelity hotspot locator provides a central calling number (e.g., an 800 number) that a user may dial using a cellular telephone or other communications device. The cellular provider will know automatically that the communication is being made to request the hotspot locator service based on the central calling number being dialed. The cellular provider, by knowing the cell that the caller telephone, or communications device, is transmitting to, can identify the location of the caller. Based on the location of the caller, the carrier identifies the hotspot sites that are closest in geographic proximity to the caller. The carrier then sends a message back to the caller identifying the hotspot location(s). For advanced cellular telephone users, a map may also be transmitted to the user. Exemplary embodiments of the present invention permit a cellular telephone user to quickly locate a convenient wireless fidelity hotspot site without having to sign on to a dial-up connection first or having to remember to bring a paper directory or having to search for warchalking marks or other signs.

In exemplary embodiments of the present invention, the cellular carrier houses a hotspot site directory, or database, that is cross-referenced against the locations of the cells within the carrier network. The database query is triggered by a communication (e.g., a telephone call) to the central calling number from the cellular telephone customer. The telephone call initiates the transmission of the location of the caller's closest cell to the carrier database. The carrier then transmits to the caller the addresses of the hotspot site(s) closest to that cell.

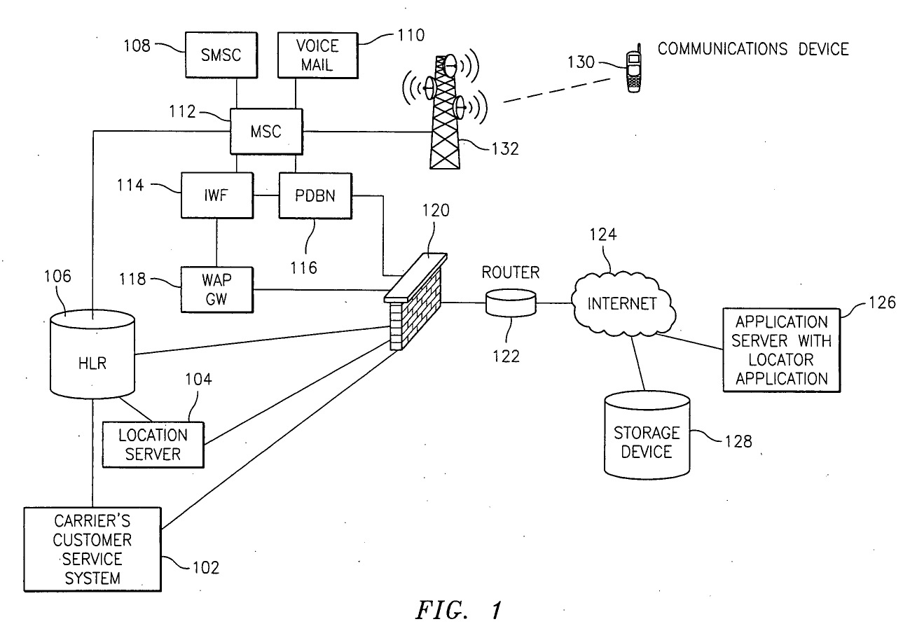

FIG. 1 is a block diagram of an exemplary system for providing a wireless fidelity hotspot locator. The system depicted in FIG. 1 includes a communications device 130 (e.g., a cellular telephone) in wireless communication with a base station 132. As is known in the art, each base station 132 is associated with a cell corresponding to a geographic location. FIG. 1 also includes a standard wireless telephone network environment with elements including a base station 132 for communicating with communications devices 130 and a mobile switching center (MSC) 112 in communication with: a short messaging service center 108 (SMSC), a voice mail system 110, a home location register 106 (HLR), an Inter Working Function (IWF) 114 and a packet data backbone network 116 (PDBN). The IWF 114 is also in communication with a wireless application protocol gateway 118 (WAP GW).

The HLR 106, as is known in the art, includes a database of customer information including customer profiles utilized in mobile (e.g., cellular) networks. In addition, the HLR 106 accesses customer information from the carrier's customer service system 102 and a location server 104 to track the current location of a communications device 130 such as a cellular telephone, personal digital appliance (PDA), wireless pager, or radio. In exemplary embodiments of the present invention, the HLR 106 sends to and receives information from the wireless fidelity hotspot locator application server 126 through a firewall 120 and via a router 122 and a network 124. In alternate exemplary embodiments of the present invention, the wireless fidelity hotspot locator application and associated database is located on the carrier's customer service system 102.

The network 124 depicted in FIG. 1 may be any type of known network including, but not limited to, a wide area network (WAN), a local area network (LAN), a global network (e.g. Internet), a virtual private network (VPN), and an intranet. The network 124 may be implemented using a wireless network or any kind of physical network implementation known in the art.

FIG. 1 also includes a hotspot directory database for storing wireless fidelity hotspot locator application data. The storage device 128 depicted in FIG. 1 may be implemented using a variety of devices for storing electronic information. It is understood that the storage device 128 may be implemented using memory contained in the server system 126 or it may be a separate physical device. The storage device 128 is logically addressable as a consolidated data source across a distributed environment that includes the network 124. The physical data accessed via the storage device 128 may be located in a variety of geographic locations depending on application and access requirements. Information stored in the storage device 128 may be retrieved and manipulated via the server system 126. In alternate exemplary embodiments of the present invention, the storage device 128 and application server system 126 are in direct communication (i.e., not via the network 124).

The storage device 128 includes a hotspot directory database. In exemplary embodiments of the present invention, the hotspot directory database is relational and includes records that correlate cell cite location information with one or more wireless fidelity hotspot sites or locations. The hotspot directory database may be implemented by an existing database utilized by a carrier to identify the hotspot locations or it may be a separate database created for the wireless fidelity hotspot locator application. The storage device 128 may also include other kinds of data such as information concerning the creating and modification of the hotspot directory database records (e.g., date and time of creation). In exemplary embodiments of the present invention, the server system 126 operates as a database server and coordinates access to application data including data stored on storage device 128.

In alternate exemplary embodiments of the present invention, the location server 104 extracts base station 132, or cell site, location information from the HLR 106 and device specific location information (e.g., GPS based location) from the communications device 130. The location server 104 may then make this location information available to the application server 126. Alternatively, the HLR 106 may take the location information from the location server 104 and send it to the application server 126. Alternate exemplary embodiments of the present invention support the use of more granular location information (e.g., GPS based data), if available, to provide a list of the closest wireless fidelity hotspot locations. For example, E911 location databases may be utilized to provide location information that is more specific than a cell site location. In these alternate exemplary embodiments of the present invention, the wireless fidelity hotspot locations are correlated to the more granular location information.

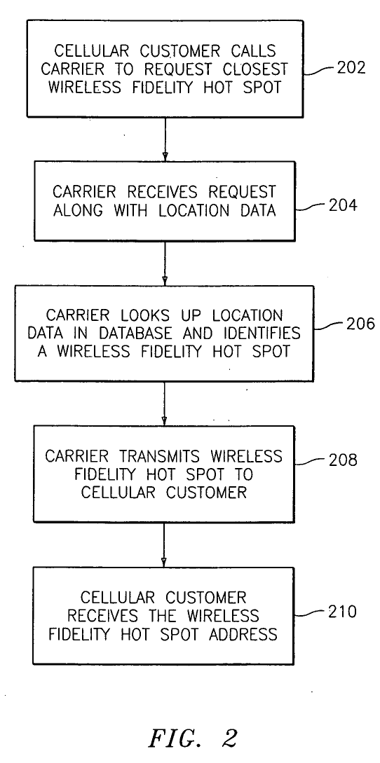

The application server 126 executes one or more computer programs to provide the wireless fidelity hotspot locator. The processing may include having the entire wireless fidelity hotspot locator application residing on the server 126 or sharing the processing of the wireless fidelity hotspot locator application between the server 126 and the communications device 130. All or portions of the wireless fidelity hotspot locator application may be located on any type of server known in the art including: a wireless markup language (WML) or wireless application protocol (WAP) server, an HTML server, a Java application server, and a BREW application server. In exemplary embodiments of the present invention, portions of the wireless fidelity hotspot locator application may also be located on the communications device 130. The system depicted in FIG. 1 is an example of one system that may be utilized by exemplary embodiments of the present invention. Any cellular network system known in the art that supports the processing described in reference to FIG. 2 may be utilized to implement exemplary embodiments of the present invention.

FIG. 2 is a flow diagram of an exemplary process for providing a wireless fidelity hotspot locator using a cellular network. At 202, a cellular customer makes a telephone call (or initiates another communication such as a message), using a communications device 130, to a central calling number reserved for providing the wireless fidelity hotspot locator. In exemplary embodiments of the present invention, the central calling number is an “800” number. In alternate exemplary embodiments of the present invention, the cellular customer selects a wireless fidelity hotspot locator menu option on the communications device 130 and the selecting results in the central calling number being dialed by the communications device 130.

At 204, the carrier receives the telephone call, via the base station 132, to the central calling number along with the telephone number of the communications device 130. The MSC 112 recognizes the central calling number as one that is reserved for providing the wireless fidelity hotspot locator and sends the data, including the request for the closest wireless fidelity hotspot site(s), the telephone number of the communications device 130 and the base station 132 to the HLR 106. At 206, the carrier system looks up the location data in the wireless fidelity hotspot locator database and identifies one or more wireless fidelity hotspot sites that correspond to the location of the base station 132. In exemplary embodiments of the present invention, 206 is implemented by the HLR 106 transmitting the base station 132 (or other more granular location data if available) to the application server 126 with a request to find the corresponding wireless fidelity hotspot site(s). In response, to the request, the wireless fidelity hotspot locator application accesses the wireless fidelity hotspot locator database located on the storage device 128 to look up the wireless fidelity hotspot location(s) associated with the base station 132. In exemplary embodiments of the present invention, when the application server 126 is in communication with a network 124 such as the Internet, the communication between the HLR 106 and the application server 126 is via the firewall 120, router 122 and network 124.

At 208, the cellular carrier transmits the wireless fidelity hotspot site(s) to the cellular customer at the communications device 130. In exemplary embodiments of the present invention, 208 is implemented by the HLR 106 sending the wireless fidelity hotspot location(s) data (text and/or graphics) and the telephone number of the communications device 130 to the MSC 112 with instructions for the MSC 112 to transmit the data to the communications device 130. At 210, the cellular customer receives the wireless fidelity hotspot site information such as a street address and/or a map (if the communications device 130 supports graphics). When more than one site is transmitted to the communications device 130, the user may be prompted to scroll through a list. In alternate exemplary embodiments, voice data relaying the wireless fidelity hotspot location information is transmitted to the communications device 130. FIG. 2 is an example of one process that may be utilized to implement the wireless fidelity hotspot locator service functions. Any process known in the art that supports the ability to identify wireless fidelity hotspots based on a communications device 130 location may be utilized by exemplary embodiments of the present invention.

Alternate exemplary embodiments of the present invention include providing a list of all wireless fidelity hotspot sites available within a pre-selected range of the communications device 130. This list includes both the carrier associated with the cellular customer (including other carriers with roaming agreements with the cellular customer carrier) as well as other carriers and the fees they charge for access to the wireless fidelity hotspot(s). This information is displayed on the communications device 130 and the cellular customer may chose between the options. Exemplary embodiments of the present invention may be extended to lookup and locate anything that falls within a category: government offices, gas stations, pizza places, doctor offices, etc.

Other alternate exemplary embodiments include a push application for communications devices 130 that include storage capacity. A cellular network customer may subscribe to a wireless fidelity hotspot locator service and be provided with periodic updates about the closest wireless fidelity hotspot site. The customer views the latest list and/or maps by accessing a menu option on the communications device 130. The updated wireless fidelity hotspot location is derived based on location data contained in the HLR 106 and or location server 104. The updates may be provided based on customer request or whenever a change in location occurs that effects the nearest wireless fidelity hotspot site, or location. These alternate exemplary embodiments of the present invention may be expanded to include push advertising (e.g., gas station that is in the area and having a special price on gasoline, an advertisement for a restaurant in the area). Other exemplary embodiments include having a carrier sell priority listings or other advertising of certain locations, similar to the way that search results and advertising are currently presented on the Internet.

Utilizing exemplary embodiments of the present invention, a cellular network customer may find wireless fidelity hotspot locations that are not immediately apparent without a directory or access to the Internet. This may result in substantial time savings for cellular network customers. In addition, exemplary embodiments of the present invention may be utilized to direct cellular network customers towards wireless fidelity hotspots that are included in the carrier network and may be less expensive for the customer to access. The suggested wireless fidelity hotspots may include only those locations that are more stable, provide high-speed access and have security functions built in. This may result in a more productive and secure Internet connection.

As described above, embodiments in the form of computer-implemented processes and apparatuses for practicing those processes. In exemplary embodiments, the wireless fidelity hotspot locator is embodied in computer program code executed by one or more network elements. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the wireless fidelity hotspot locator. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the wireless fidelity hotspot locator. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

1. A method for providing a wireless fidelity hotspot locator, the method comprising:
receiving a communication from a communications device requesting to locate a wireless fidelity hotspot;
determining a location of the communications device;
determining a wireless fidelity hotspot site that corresponds to the location; and
transmitting address information for the hotspot site to the communications device.

2. The method of claim 1 wherein the communication is received via a base station and the location of the communications device is a cell corresponding to the base station.

3. The method of claim 1 wherein the communication is received in response to a user dialing a central calling number or messaging a central address on the communications device.

4. The method of claim 1 wherein the communication is received in response to a user selecting a menu option on the communications device.

5. The method of claim 1 wherein the communication is a telephone call or other type of wireless communication.

6. The method of claim 1 wherein the communication is a message.

7. The method of claim 1 wherein the communications device is a cellular telephone.

8. The method of claim 1 wherein the address information includes text data.

9. The method of claim 1 wherein the address information includes graphics data.

10. The method of claim 9 wherein the graphics data includes a map.

11. The method of claim 1 wherein the address information includes voice data.

12. The method of claim 1 wherein the determining a wireless fidelity hotspot site includes accessing a hotspot directory database to look up the wireless fidelity hotspot site that corresponds to the location.

13. The method of claim 12 wherein records in the hotspot directory database include a location field and one or more wireless fidelity hotspot site fields, the wireless fidelity hotspot site fields including address information fields.

14. The method of claim 13 wherein the records further include a carrier field and a fee field.

15. The method of claim 12 wherein the hotspot directory database is a relational database.

16. The method of claim 1 further comprising transmitting carrier and fee information for the hotspot site to the communications device.

17. The method of claim 1 further comprising determining a business entity that corresponds to the location and transmitting address information for the business entity to the communications device.

18. A method for providing a wireless fidelity hotspot locator, the method comprising:
determining a location of a communications device that subscribes to a wireless fidelity hotspot locator service;
determining a wireless fidelity hotspot site that corresponds to the location; and
transmitting address information for the hotspot site to the communications device.

19. The method of claim 18 further comprising determining an advertiser that corresponds to the location and transmitting address information for the advertiser to the communications device.

20. A system for providing a wireless fidelity hotspot locator, the system comprising:
an application server;
a switch in communication with the application server; and
a wireless fidelity hotspot locator application accessed by the application server for:
receiving a communication from a communications device via the switch requesting to locate a wireless fidelity hotspot;
determining a location of the communications device;
determining a wireless fidelity hotspot site that corresponds to the location; and
transmitting address information for the hotspot site to the communications device via the switch.

21. A computer program product for providing a wireless fidelity hotspot locator, the computer program product comprising:
a computer-readable storage medium for storing instructions for executing the wireless fidelity hotspot locator, the wireless fidelity hotspot locator service comprising a method of:
receiving a communication from a communications device requesting to locate a wireless fidelity hotspot;
determining a location of the communications device;
determining a wireless fidelity hotspot site that corresponds to the location; and
transmitting address information for the hotspot site to the communications device.
